(19) United States
(12) Patent Application Publication
(10) Pub. No.: US 2024/0380276 A1
(43) Pub. Date: Nov. 14, 2024

(54) BRAKE APPARATUS, VEHICLE HAVING THE SAME AND METHOD FOR BRAKING VEHICLE

(71) Applicant: HL MANDO CORPORATION, Gyeonggi-do (KR)

(72) Inventor: Hanjun LEE, Gyeonggi-do (KR)

(21) Appl. No.: 18/387,589

(22) Filed: Nov. 7, 2023

(30) Foreign Application Priority Data
May 10, 2023 (KR) 10-2023-0060336

(51) Int. Cl. H02K 7/104

(52) U.S. Cl. CPC H02K 7/104

(57) ABSTRACT

A brake apparatus includes: a brake controller configured to receive an output signal of a pedal travel sensor and generate current corresponding to a braking force based on the output signal; a disc interface configured to receive the generated current; and a brake disc electrically connected to the disc interface, wherein the generated current generates an electromagnetic force while flowing through the disc interface and the brake disc, and the brake disc is configured to stop rotating or be reduced in rotation speed by the generated electromagnetic force.

### CROSS-REFERENCE TO RELATED APPLICATION(S)

This application is based on and claims priority under 35 U.S.C. § 119 to Korean Patent Application No. 10-2023-0060336, filed on May 10, 2023, in the Korean Intellectual Property Office, the disclosure of which is incorporated by reference herein in its entirety.

### BACKGROUND

### 1. Field

The disclosure relates to a brake apparatus for braking a vehicle using an electromagnetic force, a vehicle including the brake apparatus, and a method for braking the vehicle.

### 2. Description of the Related Art

Brake systems for brake are essential to vehicles, and various types of brake systems are proposed for the safety of drivers and passengers.

An existing brake system brakes a vehicle using a frictional force generated between brake pads and a brake disc. The brake system provides hydraulic pressure (brake oil pressure) required for braking to wheel cylinders according to a driver's braking intention or a command from the system.

However, in this method, the brake pads should be periodically replaced due to wear, and there is a risk of brake oil leakage. In addition, an actuator required for braking by hydraulic pressure increases the volume and weight of the brake system, and the risk of electronic control unit (ECU) burnout also exists.

### SUMMARY

It is an aspect of the disclosure to provide a brake apparatus capable of braking a vehicle without causing wear of components or brake oil leakage by generating a torque in an opposite direction of a driving direction by using a Lorentz force, a vehicle including the brake apparatus, and a method for braking the vehicle.

Additional aspects of the disclosure will be set forth in part in the description which follows and, in part, will be obvious from the description, or may be learned by practice of the disclosure.

A brake apparatus according to an embodiment includes: a brake controller configured to receive an output signal of a pedal travel sensor and generate current corresponding to a braking force based on the output signal; a disc interface configured to receive the generated current; and a brake disc electrically connected to the disc interface, wherein the generated current generates an electromagnetic force while flowing through the disc interface and the brake disc, and the brake disc is configured to stop rotating or be reduced in rotation speed by the generated electromagnetic force.

The disc interface may include a first interface provided on one side of the brake disc; and a second interface provided on another side of the brake disc.

The brake controller may apply the generated current to an interface between the first interface and the second interface.

The brake controller may select an interface between the first interface and the second interface such that the electromagnetic force is generated in an opposite direction of a driving direction of the vehicle, and apply the generated current to the selected interface between the first interface and the second interface.

The brake controller may apply the generated current to the first interface such that the electromagnetic force is generated in a backward direction of the vehicle.

The brake controller may apply the generated current to the second interface such that the electromagnetic force is generated in a forward direction of the vehicle.

The brake disc may include a first disc plate, a second disc plate, and at least one connector positioned between the first disc plate and the second disc plate.

The generated current may generate the electromagnetic force in an opposite direction of a driving direction of the vehicle while flowing through the first interface, the first disc plate, the at least one connector, the second disc plate, and the second interface.

The first interface includes a first brush being in contact with the first disc plate. Further, the second interface includes a second brush being in contact with the second disc plate.

The generated current may generate a magnetic field while flowing through the first interface and the second interface. Further, the electromagnetic force may correspond to a Lorentz force generated by the current and the magnetic field.

A vehicle according to an embodiment includes: a pedal travel sensor configured to output an output signal corresponding to a movement of a brake pedal; a brake controller configured to generate current corresponding to a braking force based on the output signal; a disc interface configured to receive the generated current; a brake disc electrically connected to the disc interface; and a wheel configured to rotate together with the brake disc, wherein the generated current generates an electromagnetic force while flowing through the disc interface and the brake disc, and the brake disc is configured to stop rotating and be reduced in rotation speed by the generated electromagnetic force.

The disc interface may include a first interface provided on one side of the brake disc; and a second interface provided on another side of the brake disc.

The brake disc may include a first disc plate; a second disc plate; and at least one connector positioned between the first disc plate and the second disc plate.

The generated current may generate the electromagnetic force in an opposite direction of a driving direction of the vehicle while flowing through the first interface, the first disc plate, the at least one connector, the second disc plate, and the second interface.

The first interface may include a first brush being in contact with the first disc plate. Further, the second interface may include a second brush being in contact with the second disc plate.

The generated current may generate a magnetic field while flowing through the first interface and the second interface. Further, the electromagnetic force may correspond to a Lorentz force generated by the current and the magnetic field.

A method for braking a vehicle, according to an embodiment, includes: receiving an output signal of a pedal travel sensor; determining an intensity and direction of current corresponding to the output signal; and applying current to a brake disc based on the determined intensity and direction of current, wherein the brake apparatus includes a first interface provided on one side of the brake disc, and a second interface provided on another side of the brake disc, the current generates an electromagnetic force while flowing through the first interface, the brake disc, and the second interface, and the brake disc is configured to stop rotating or be reduced in rotation speed by the generated electromagnetic force.

The determining of the intensity and direction of current may include selecting an interface between the first interface and the second interface such that the electromagnetic force is generated in an opposite direction of a driving direction of the vehicle. Further, the applying of the current may include applying the generated current to the selected interface between the first interface and the second interface.

The brake disc may include a first disc plate; a second disc plate; and at least one connector positioned between the first disc plate and the second disc plate. Further, the generated current may generate the electromagnetic force in an opposite direction of a driving direction of the vehicle while flowing through the first interface, the first disc plate, the at least one connector, the second disc plate, and the second interface.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram showing components included in a vehicle according to an embodiment;

FIG. 2 is a diagram conceptually illustrating an operation of a brake system according to an embodiment;

FIG. 3 is a diagram showing a configuration of a brake system according to an embodiment;

FIG. 4 is a view for explaining a principle of braking a vehicle by a brake system according to an embodiment;

FIG. 5 is a view for explaining a principle of braking a vehicle by a brake system according to an embodiment;

FIG. 6 is a view embodying a configuration of a brake system according to an embodiment;

FIG. 7 is a view embodying a configuration of a brake system according to an embodiment;

FIG. 8 is a view illustrating an operation of a brake system for braking a vehicle traveling forward;

FIG. 9 is a view illustrating an operation of a brake system for braking a vehicle traveling forward;

FIG. 10 is a view illustrating an operation of a brake system for braking a vehicle moving backward;

FIG. 11 is a view illustrating an operation of a brake system for braking a vehicle moving backward; and

FIG. 12 is a flowchart illustrating a method for braking a vehicle according to an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

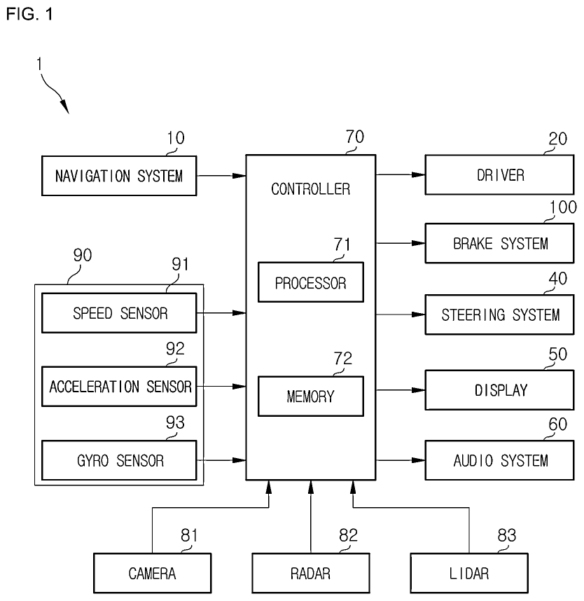

FIG. 1 is a block diagram showing components included in a vehicle according to an embodiment.

As shown in FIG. 1, a vehicle 1 may include a navigation system 10, a driver 20, a brake system 100, a steering system 40, a display 50, an audio system 60, a behavior sensor 90, a camera 81, a radar 82, and a lidar 83.

The navigation system 10 may generate a route to a destination input by a driver and provide the generated route to the driver. The navigation system 10 may receive a GNSS signal from a Global Navigation Satellite System (GNSS) and identify an absolute position (coordinates) of the vehicle 1 based on the GNSS signal. The navigation system 10 may generate the route to the destination based on a position (coordinates) of the destination input by the driver and a current position (coordinates) of the vehicle 1.

The driver 20 may generate power required for moving the vehicle 1. For example, the driver 20 may include an engine, an Engine Management System (EMS), a transmission, and a Transmission Control Unit (TCU).

The engine may generate power for driving the vehicle 1, and the engine management system may control the engine in response to a driver's intention to accelerate through an accelerator pedal or a request from a driving assistance system. The transmission may reduce power generated by the engine and then transfer the power to wheels, and the transmission control unit may control the transmission in response to the driver's shift command through a shift lever and/or a request from the driving assistance system.

Also, the driver 20 may include a driving motor, a speed reducer, a battery, a power control device, etc. In this case, the vehicle 1 may be implemented as an electric vehicle.

Also, the driver 20 may include all of devices related to the engine and devices related to the driving motor. In this case, the vehicle 1 may be implemented as a hybrid vehicle.

The brake system 100 may reduce speed of the vehicle 1. The brake system 100 may generate a braking force for braking the vehicle 1 in response to the driver's braking intention input through the brake pedal or a request from a controller 70. A detailed description about the brake system 100 will be described below.

The steering system 40 may include an Electronic Power Steering Control Module (EPS). The steering system 40 may change a driving direction of the vehicle 1, and the electronic power steering control module may assist an operation of the steering system 40 in response to the driver's intention to steer through a steering wheel to enable the driver to easily control the steering wheel.

In addition, the electronic power steering control module may control the steering system 40 in response to a request from the controller 70. For example, the electronic power steering control module may receive a steering request including a steering torque from the controller 70, and control the steering system 40 to steer the vehicle 1 based on the requested steering torque.

The display 50 may include a cluster, a head-up display, a center fascia monitor, etc., and provide various information and entertainment to the driver through images. For example, the display 50 may provide the driver with driving information of the vehicle 1, warning messages, etc.

The audio system 60 may include a plurality of speakers, and provide the driver with various information and entertainment through sound. For example, the audio system 60 may provide the driver with driving information of the vehicle 1, warning messages, etc.

The behavior sensor 90 may include at least one among a speed sensor 91 for detecting speed of the vehicle 1, an acceleration sensor 92 for detecting an acceleration in longitudinal direction of the vehicle 1 and an acceleration in traverse direction of the vehicle 1, or a gyro sensor 93 for detecting a yaw rate, a roll rate, or a pitch rate of the vehicle 1.

The above-mentioned components may transmit/receive data to/from each other through an in-vehicle communication network. More specifically, the above-mentioned components included in the vehicle 1 may transmit/receive data to/from each other through an in-vehicle communication network, such as the Ethernet, Media Oriented Systems Transport (MOST), Flexray, Controller Area Network (CAN), Local Interconnect Network (LIN), etc.

For example, the controller 70 may communicate with the navigation system 10, the driver 20, the brake system 100, the steering system 40, the display 50, the audio system 60, the camera 81, the radar 82, the lidar 83, and the behavior sensor 90 through the in-vehicle communication network.

The controller 70 may use data provided from other components of the vehicle 1 as a basis for recognition/determination, and transfer a control signal for controlling the vehicle 1 to the other components of the vehicle 1 based on a result of the recognition/determination.

Also, the vehicle 1 according to an embodiment may further include a communication module for communicating with another external device, although not shown in the drawing. The communication module may wirelessly communicate with a base station or an Access Point (AP) and transmit/receive data to/from external devices via the base station or access point.

For example, the communication module may wirelessly communicate with the AP using Wireless-Fidelity (Wi-Fi) (WiFi™, IEEE 802.11 technology standard), or the communication module may communicate with the base station by using Code Division Multiple Access (CDMA), Wideband Code Division Multiple Access (WCDMA), Global System for Mobile communications (GSM), Long Term Evolution (LTE), 5th generation (5G), Wireless Broadband (WiBro), etc.

Also, the communication module may directly communicate with external devices. For example, the communication module may transmit/receive data to/from external devices in a short distance by using Wi-Fi Direct, Bluetooth (Bluetooth™, IEEE 802.15.1 technical standard), ZigBee (ZigBee™, IEEE 802.15.4 technical standard), etc.

Meanwhile, all the components shown in FIG. 1 may be not necessarily included in the vehicle 1. For example, at least one of the camera 81, the radar 120, or the lidar 130 may be omitted.

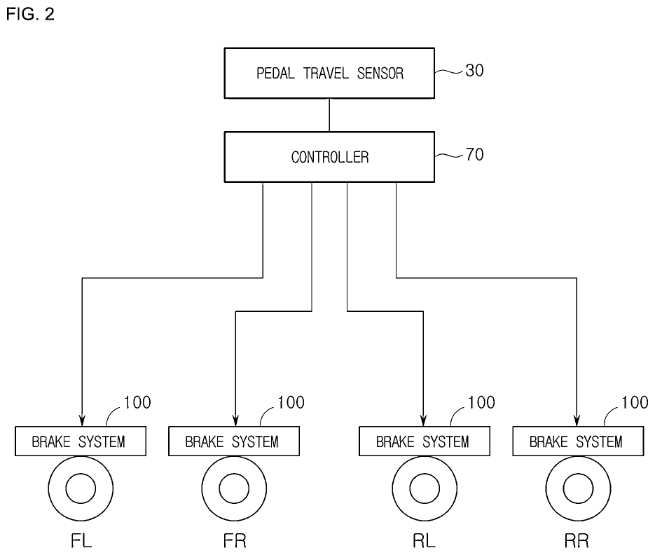

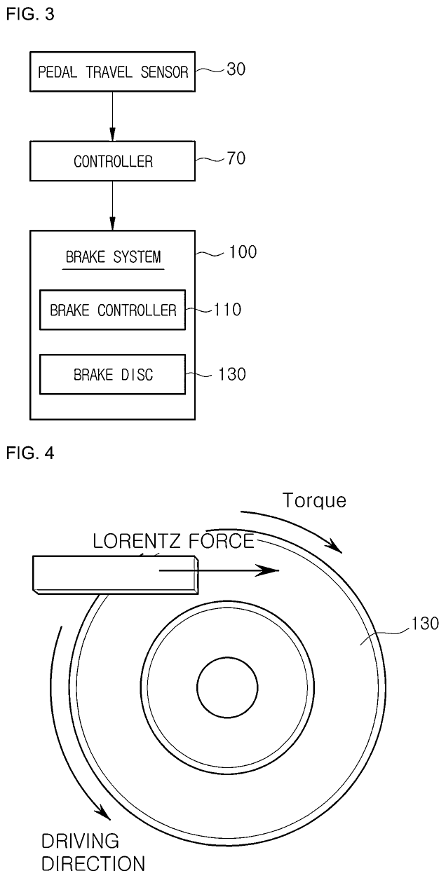

FIG. 2 is a diagram conceptually illustrating an operation of a brake system according to an embodiment, and FIG. 3 is a diagram showing a configuration of a brake system according to an embodiment.

For example, the brake system 100 may correspond to each of four wheels FL, FR, RL, and RR. More specifically, as shown in FIG. 2, the brake system 100 may correspond to each of a left front wheel FL, a right front wheel FR, a left rear wheel RL, and a right rear wheel RR to brake the wheels FL, FR, RL, and RR independently.

A pedal travel sensor 30 may be installed near the brake pedal and may measure the movement of the brake pedal by the driver's braking intention. For example, the pedal travel sensor may detect a moving distance from a reference position and/or a moving speed of the brake pedal.

The pedal travel sensor 30 may be electrically connected to the controller 70 and may provide the electrical signal (pedal travel signal) corresponding to the moving distance and/or the moving speed of the brake pedal to the controller 70. For example, the pedal travel sensor 30 may be directly connected to the controller 70 via a hard wire or connected to the controller 70 via a communication network.

The controller 70 may generate a braking command for braking the vehicle 1 based on the driver's braking intention or a surrounding situation, and the generated braking command may be transmitted to the brake system 100 to brake the wheels FL, FR, RL, and RR independently.

Referring to FIG. 3, the brake system 100 may include a brake disc 130 that rotates together with a wheel, and a brake controller 110 that controls a rotation of the brake disc 130.

The brake disc 130 may be provided for each wheel. For example, the brake disc 130 may be provided in each of the left front wheel FL, the right front wheel FR, the left rear wheel RL, and the right rear wheel RR to rotate together with each of the wheels FL, FR, RL, and RR.

The brake system 100 may brake the vehicle 1 by stopping rotating the brake disc 130 or reducing rotation speed of the brake disc 130.

An existing brake system includes brake pads provided on both sides of a brake disc, and brakes a vehicle by pressing the brake disc from the both sides using the brake pads.

However, in this method, the brake pads are worn due to a frictional force with the brake disc, and accordingly, the brake pads need to be periodically replaced. In addition, a hydraulic pressure control for pressurizing the brake disc is required, and there are risks of leakage of brake oil used for the hydraulic pressure control or electronic control unit (ECU) burnout by an actuator.

Therefore, the vehicle 1 and the brake system 100 according to an embodiment may stop rotating the brake disc or reduce rotation speed of the brake disc by using an electromagnetic force instead of a frictional force, thereby implementing braking of the vehicle. Hereinafter, related operations will be described in detail.

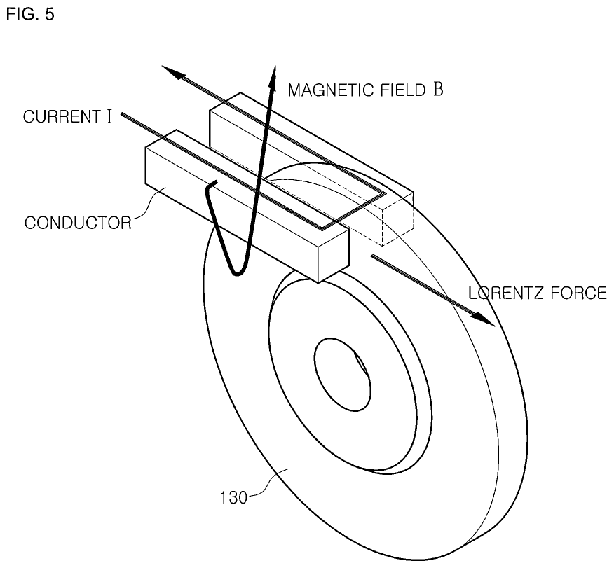

FIG. 4 is a view for explaining a principle of braking a vehicle by a brake system according to an embodiment. FIG. 5 is a view for explaining a principle of braking a vehicle by a brake system according to an embodiment.

Referring to FIG. 4, the brake system 100 according to an embodiment may use an electromagnetic force, instead of a frictional force, to stop rotating the brake disc 130 or reduce rotation speed of the brake disc 130. For example, the brake system 100 may stop rotating the brake disc 130 or reduce rotation speed of the brake disc 130 by using a Lorentz force.

More specifically, the brake system 100 may generate a Lorentz force in an opposite direction of a driving direction. The Lorentz force generated in the opposite direction of the driving direction may act as a torque in an opposite direction of a rotation direction of the brake disc 130, resulting in braking of the vehicle 1.

Referring to FIG. 5, the brake system 100 may include conductors respectively provided on both sides of the brake disc 130, respectively. When current I is applied to the conductors, a magnetic field B may be generated, and a Lorentz force as an electromagnetic force generated by the current I and the magnetic field B may be generated, as shown in FIG. 5.

To brake the vehicle 1, a direction of the Lorentz force needs to be considered. Accordingly, application of current may be controlled such that the Lorentz force is generated in a direction that is opposite to a driving direction of the vehicle 1, based on a rule for determining a direction of an electromagnetic force generated by current and a magnetic field.

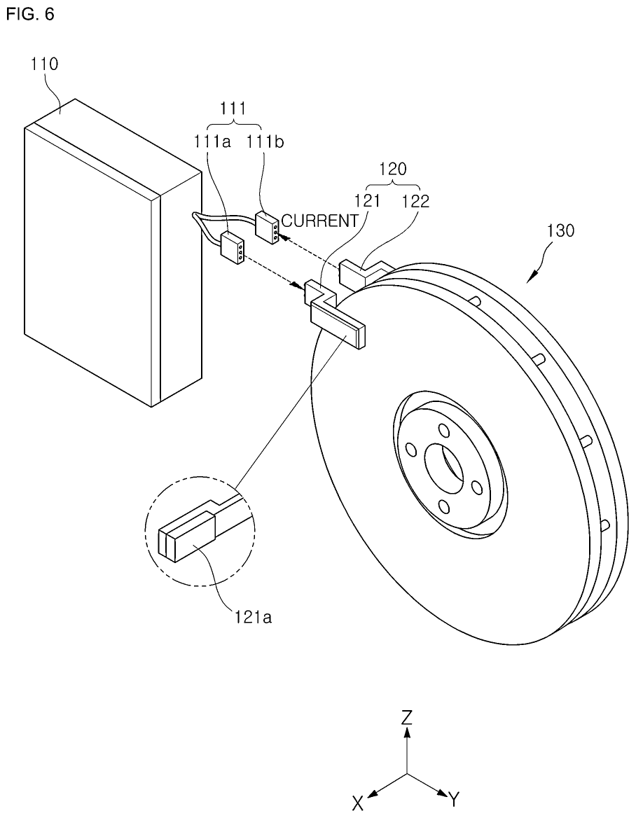

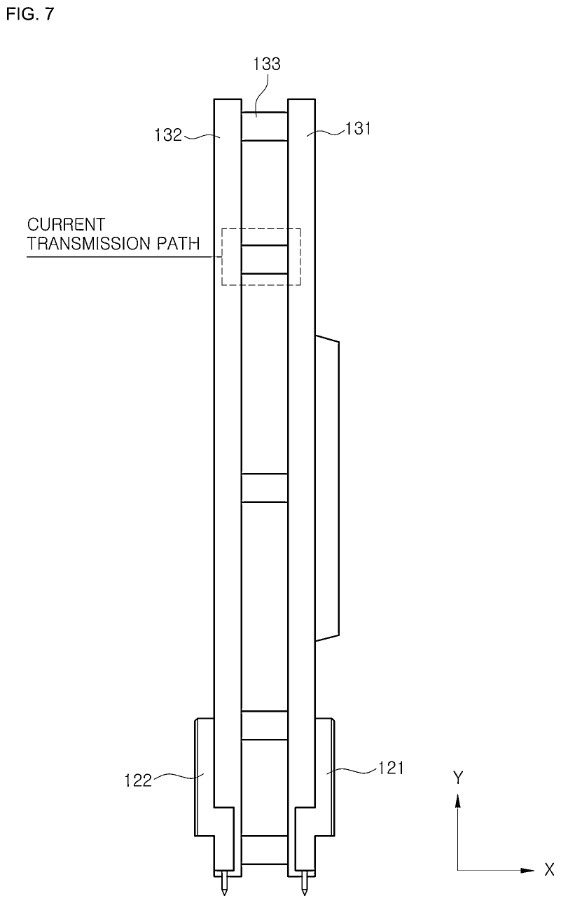

FIG. 6 is a view embodying a configuration of a brake system according to an embodiment. FIG. 7 is a view embodying a configuration of a brake system according to an embodiment.

As described above, the brake system 100 according to an embodiment may include the brake disc 130 and the brake controller 110.

The brake controller 110 may generate current required to stop rotating the brake disc 130 or reduce rotation speed of the brake disc 130. The generated current may be transferred to the brake disc 130 through a controller interface 111.

The brake system 100 may include a disc interface 120 provided on both sides of the brake disc 130 to receive current transferred from the brake controller 110. For example, the disc interface 120 may include a conductor that serves as a field magnet, and include a first interface 121 provided on one side of the brake disc 130 and a second interface 122 provided on another side of the brake disc 130.

Referring to FIG. 7 together, the brake disc 130 may include a first disc plate 131 and a second disc plate 132. The first disc plate 131 may face the second disc plate 132 in such a way to be spaced apart from the second disc plate 132, and a connector 133 connecting the first disc plate 131 to the second disc plate 132 may be positioned in a space between the first disc plate 131 and the second disc plate 132.

The first interface 121 may be in contact with the first disc plate 131, and the second interface 122 may be in contact with the second disc plate 132. Also, the first interface 121 and the second interface 122 may include brushes 121a, respectively. The first and second interfaces 121 and 122 may be in contact with the first and second disc plates 131 and 132 through the brushes 121a, thereby reducing friction and improving durability.

The connector 133 may serve as an armature, and current received by the first interface 121 or the second interface 122 may flow through the connector 133 via the first disc plate 131 or the second disc plate 132.

The current flowing through the connector 133 may be transmitted to the opposite second disc plate 132 or the opposite first disc plate 131, and then enter the controller interface 111 through the second interface 122 or the first interface 121.

Due to current flowing through the disc interface 120 serving as a field magnet and the connector 133 serving as an armature, a magnetic field B may be generated in a direction that is perpendicular to a direction of the current. Also, a Lorentz force, that is, an electromagnetic force may be generated in a direction that is perpendicular to the direction of the current and the direction of the magnetic field B.

An electromagnetic force generated in an opposite direction of a driving direction of the vehicle 1 may act as a torque in an opposite direction of a rotation direction of the brake disc 130, and the vehicle 1 may be braked by the torque.

Meanwhile, a plurality of connectors 133 may be provided between the first disc plate 131 and the second disc plate 132. Because current supplied from the brake controller 110 flows through the connectors 133, a finer torque control may be possible as a number of the connectors 133 increases.

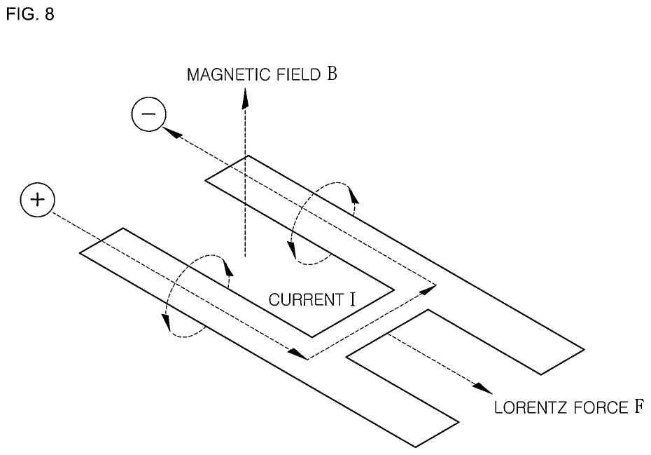

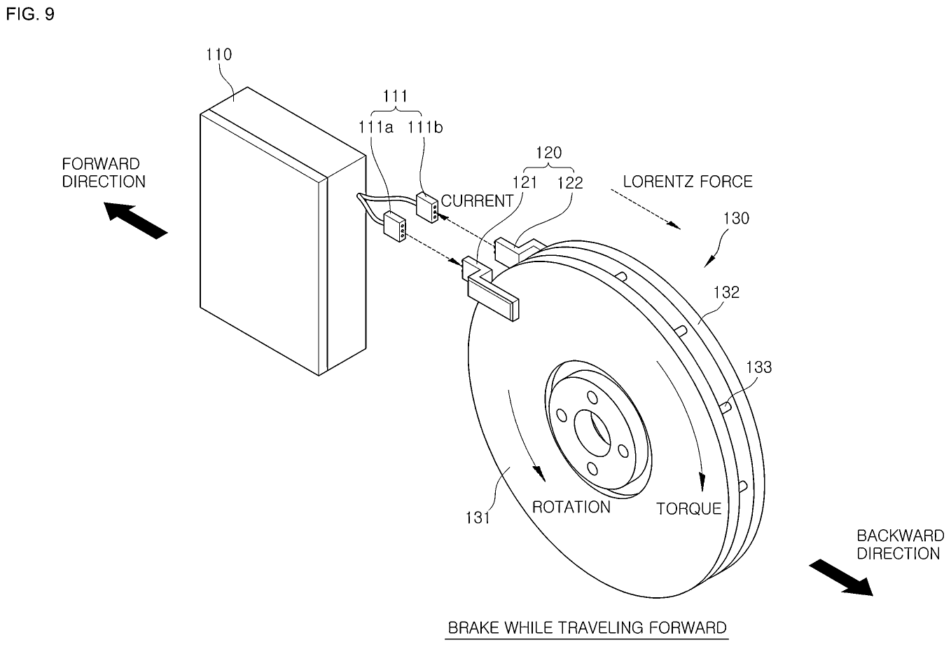

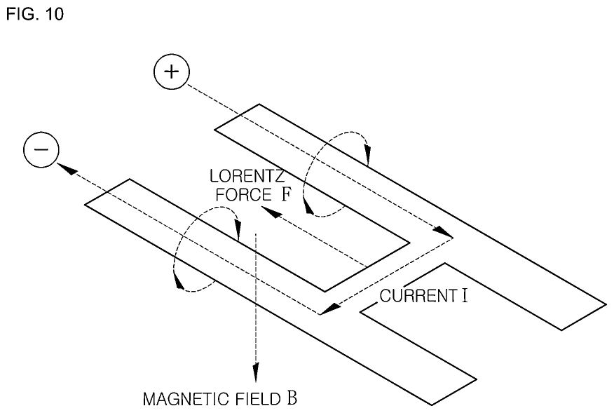

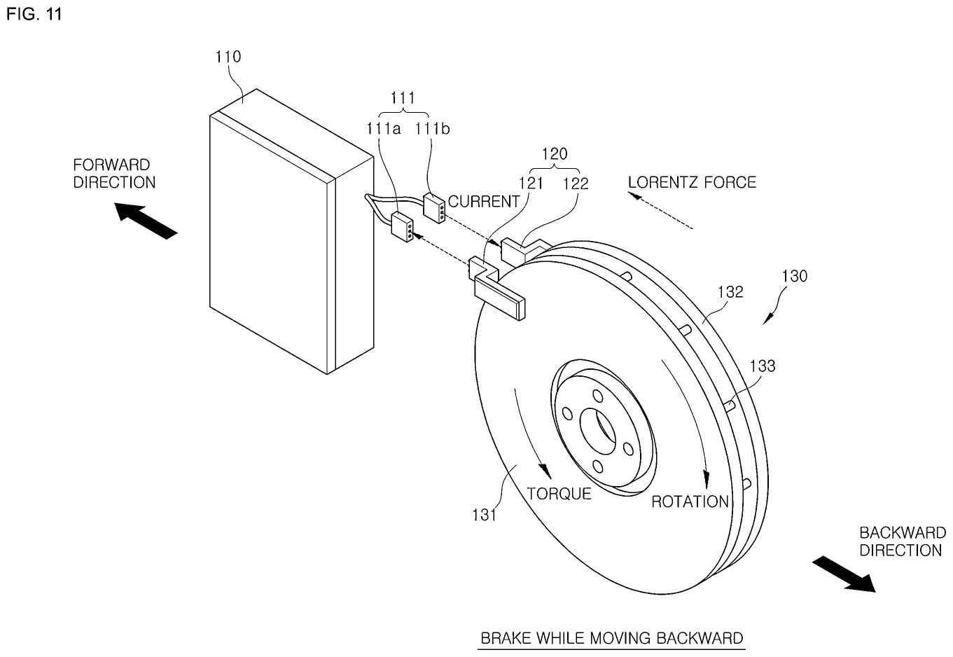

FIG. 8 is a view illustrating an operation of a brake system for braking a vehicle traveling forward. FIG. 9 is a view illustrating an operation of a brake system for braking a vehicle traveling forward. FIG. 10 is a view illustrating an operation of a brake system for braking a vehicle moving backward. FIG. 11 is a view illustrating an operation of a brake system for braking a vehicle moving backward.

As described above, the brake system 100 according to an embodiment may brake the vehicle 1 using a Lorentz force. For this, the Lorentz force may need to be generated in an opposite direction of a driving direction of the vehicle 1, and accordingly, the brake controller 110 may control application of current based on the driving direction of the vehicle 1.

FIG. 8 is a diagram conceptually illustrating a flow direction of current and a direction of a generated force, and FIG. 9 shows a brake system according to an embodiment to which application of current shown in FIG. 8 is applied.

Referring to FIGS. 8 and 9 together, while the vehicle 1 travels forward, current may be applied from the first interface 111a of the brake controller 110 to the first interface 121 of the disc interface 120.

The current applied to the first interface 121 may be transferred to the second disc plate 132 via the first disc plate 131 and the connector 133, and may again enter the second interface 111b of the brake controller 110 via the second disc plate 132 and the second interface 122.

While current I flows through this path, a magnetic field B may be formed upward as shown in FIG. 8, and by the rule (for example, Fleming's left hand rule) for determining the direction of an electromagnetic force according to the direction of current and the direction of a magnetic field, a Lorentz force may be generated in a backward direction.

The Lorentz force generated in the backward direction may act as torque in an opposite direction of a rotation direction of the brake disc 130 to brake the vehicle 1 traveling forward.

Referring to FIGS. 10 and 11 together, while the vehicle 1 moves backward, current may be applied from the second interface 111b of the brake controller 110 to the second interface 122 of the disc interface 120.

The current applied to the second interface 122 may be transferred to the first disc plate 131 via the second disc plate 132 and the connector 133, and may again enter the first interface 111a of the brake controller 110 via the first disc plate 131 and the first interface 121.

While current I flows through this path, a magnetic field B may be formed downward as shown in FIG. 11, and by the rule (for example, Fleming's left hand rule) for determining the direction of an electromagnetic force according to the direction of current and the direction of a magnetic field, a Lorentz force may be generated in a forward direction.

The Lorentz force generated in the forward direction may act as torque in an opposite direction of a rotation direction of the brake disc 130 to brake the vehicle 1 moving backward.

In this way, when a braking command is input, the brake controller 110 may determine a direction in which current is applied, according to a driving direction of the vehicle 1. As described above, while the vehicle 1 travels forward, the brake controller 110 may apply current through the first interface 11a, and while the vehicle 1 moves backward, the brake controller 110 may apply current through the second interface 111b.

Also, the brake controller 110 may determine an intensity of current according to a required braking force. Also, the brake controller 110 may function as an Anti-lock Brake System (ABS) or Traction Control System (TCS) by switching application of current.

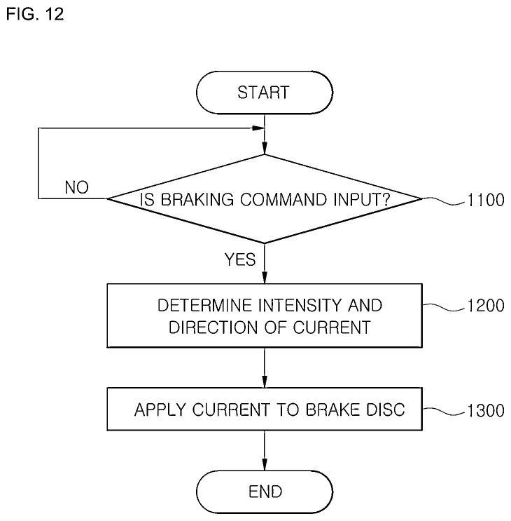

FIG. 12 is a flowchart illustrating a method for braking a vehicle according to an embodiment.

The method for braking the vehicle according to an embodiment may be performed by the brake system 100 according to the above-described embodiment or the vehicle 1 including the brake system 100. Accordingly, the above descriptions about the brake system 100 or the vehicle 1 may be applied in the same way to the embodiment of the method for braking the vehicle, unless otherwise noted. In the other way, the following descriptions about the method for braking the vehicle according to an embodiment may also be applied in the same way to the brake system 100.

Referring to FIG. 12, when a braking command is input to the brake system 100 (YES in operation 1100), the brake controller 110 may determine an intensity and direction of current corresponding to the braking command (operation 1200).

The method for braking the vehicle according to an embodiment may stop rotating the brake disc 130 or reduce rotation speed of the brake disc 130 by using a torque generated by a Lorentz force. For this, the brake system 100, which is used for the method for braking the vehicle according to an embodiment, may have a configuration shown in FIG. 6.

The brake controller 110 may determine the intensity and direction of current to be applied to the brake disc 130 based on a magnitude and direction of a braking force required for braking the vehicle 1. A direction of current that is applied while the vehicle 1 travels forward may be different from a direction of current that is applied while the vehicle 1 moves backward.

The brake controller 110 may apply current to the brake disc 130 according to the determined intensity and direction (operation 1300).

The controller interface 111 and the disc interface 120 may be used to apply current. As shown in FIGS. 8 and 9 described above, while the vehicle 1 travels forward, current may be applied from the first interface 111a of the controller interface 111 to the first interface 121 of the disc interface 120.

The current applied to the first interface 121 may be transferred to the second disc plate 132 via the first disc plate 131 and the connector 133, and may again enter the second interface 111b of the brake controller 110 via the second disc plate 132 and the second interface 122.

While current I flows through this path, a magnetic field B may be formed upward as shown in FIG. 8, and by the rule (for example, Fleming's left hand rule) for determining the direction of an electromagnetic force according to the direction of current and the direction of a magnetic field, a Lorentz force may be generated in a backward direction.

The Lorentz force generated in the backward direction may act as torque in an opposite direction of a rotation direction of the brake disc 130 to brake the vehicle 1 traveling forward.

Referring to FIGS. 10 and 11 together, while the vehicle 1 moves backward, current may be applied from the second interface 111b of the controller interface 111 to the second interface 122 of the disc interface 120.

The current applied to the second interface 122 may be transferred to the first disc plate 131 via the second disc plate 132 and the connector 133, and may again enter the first interface 111a of the brake controller 110 via the first disc plate 131 and the first interface 121.

While current I flows through this path, a magnetic field B may be formed downward as shown in FIG. 11, and by the rule (for example, Fleming's left hand rule) for determining the direction of an electromagnetic force according to the direction of current and the direction of a magnetic field, a Lorentz force may be generated in a forward direction.

The Lorentz force generated in the forward direction may act as torque in an opposite direction of a rotation direction of the brake disc 130 to brake the vehicle 1 moving backward.

The disclosed embodiments may be implemented in the form of a recording medium that stores instructions executable by a computer. For example, instructions for performing the braking method described above may be stored in the form of program codes, and when executed by a processor, the instructions may perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium. For example, a ‘non-transitory storage medium’ may include a buffer in which data is temporarily stored.

By braking the vehicle using an electromagnetic force, as described above, the brake system may be semi-permanently used because there is no component having wear property, such as existing brake pads.

Also, because a rotation of the brake disc is directly controlled and hydraulic pressure for pressing the brake pads is not required, the risk of brake oil leakage may be prevented.

In addition, because an actuator, such as a motor, a valve, etc., for driving the brake pads is not required, the risk of ECU burnout may be low.

Also, because a volume and weight are reduced compared to existing brake systems, applications to personal mobility or micro mobility may be possible.

Because the existing brake systems are 2^{nd}-order systems that control hydraulic pressure through current and the brake system according to an embodiment is a 1^{st}-order system by a current control, a brake response may be improved.

According to an aspect of the disclosure, by generating a torque in an opposite direction of a driving direction by using a Lorentz force, it may be possible to brake the vehicle without causing wear of components or brake oil leakage.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A brake apparatus comprising:
a brake controller configured to receive a brake command for braking a vehicle and generate a current corresponding to a braking force based on the brake command;
a brake disc; and
a disc interface configured to receive the generated current from the brake controller, the disc interface electrically connected to the brake disc such that the current generated by the brake controller flows through the disc interface and the brake disc to generate an electromagnetic force causing the brake disc to be braked.

2. The brake apparatus of claim 1, wherein the disc interface includes:
a first interface provided on one side of the brake disc; and
a second interface provided on another side of the brake disc.

3. The brake apparatus of claim 2, wherein the brake controller is configured to apply the generated current to one of the first interface and the second interface.

4. The brake apparatus of claim 2, wherein the brake controller is configured to:
select one of the first and second interfaces which allows to generate the electromagnetic force in a direction opposite to a driving direction of the vehicle, and
apply the generated current to the selected one of the first and second interfaces.

5. The brake apparatus of claim 2, wherein the brake controller is configured to apply the generated current to the first interface to generate the electromagnetic force in a backward direction of the vehicle.

6. The brake apparatus of claim 2, wherein the brake controller is configured to apply the generated current to the second interface to generate the electromagnetic force in a forward direction of the vehicle.

7. The brake apparatus of claim 2, wherein the brake disc includes:
a first disc plate;
a second disc plate; and
at least one connector electrically connecting between the first disc plate and the second disc plate.

8. The brake apparatus of claim 7, wherein the brake controller is configured to generate the current to generate the electromagnetic force in a direction opposite to a driving direction of the vehicle while the generated current flows through the first interface, the first disc plate, the at least one connector, the second disc plate, and the second interface.

9. The brake apparatus of claim 7, wherein:
the first interface includes a first brush being in contact with the first disc plate, and
the second interface includes a second brush being in contact with the second disc plate.

10. The brake apparatus of claim 2, wherein the brake controller is configured to generate the current to generate a magnetic field while the generated current flows through the first interface and the second interface such that the electromagnetic force corresponds to a Lorentz force generated by the current and the magnetic field.

11. A vehicle comprising:
a brake controller configured to generate a current corresponding to a braking force based on a brake command for braking the vehicle;
a brake disc;
a wheel configured to rotate with the brake disc; and
a disc interface configured to receive the generated current from the brake controller, the disc interface electrically connected to the brake disc such that the current generated by the brake controller flows through the disc interface and the brake disc to generate an electromagnetic force causing the brake disc to be braked.

12. The vehicle of claim 11, wherein the disc interface includes:
a first interface provided on one side of the brake disc; and
a second interface provided on another side of the brake disc.

13. The vehicle of claim 12, wherein the brake controller is configured to apply the generated current to one of the first and second interfaces.

14. The vehicle of claim 12, wherein the brake disc includes:
a first disc plate;
a second disc plate; and
at least one connector electrically connecting between the first disc plate and the second disc plate.

15. The vehicle of claim 14, wherein the brake controller is configured to generate the current to generate the electromagnetic force in a direction opposite to a driving direction of the vehicle while the generated current flows through the first interface, the first disc plate, the at least one connector, the second disc plate, and the second interface.

16. The vehicle of claim 14, wherein:
the first interface includes a first brush being in contact with the first disc plate, and
the second interface includes a second brush being in contact with the second disc plate.

17. The vehicle of claim 12, wherein the brake controller is configured to generate the current to generate a magnetic field while the generated current flows through the first interface and the second interface such that the electromagnetic force corresponds to a Lorentz force generated by the current and the magnetic field.

18. A method for braking a vehicle, the method comprising:
determining an intensity and direction of a current corresponding to a brake command for braking the vehicle;
applying the current to a brake disc through one of a first interface provided on one side of the brake disc and a second interface provided on another side of the brake disc such the current generates an electromagnetic force while flowing through the first interface, the brake disc, and the second interface and the generated electromagnetic force causes the brake disc to be braked.

19. The method of claim 18, wherein:
the determining of the intensity and direction of the current includes selecting one of the first and second interfaces which allows to generate the electromagnetic force in a direction opposite to a driving direction of the vehicle, and
the applying of the current to the brake disk includes applying the generated current to the selected one of the first and second interfaces.

20. The method of claim 18, wherein:
the brake disc includes: a first disc plate; a second disc plate; and at least one connector electrically connecting between the first disc plate and the second disc plate, and
the current applied to the brake disc generates the electromagnetic force in a direction opposite to a driving direction of the vehicle while flowing through the first interface, the first disc plate, the at least one connector, the second disc plate, and the second interface.
